(19) United States
(12) Patent Application Publication
(10) Pub. No.: US 2018/0217790 A1
(43) Pub. Date: Aug. 2, 2018

(54) JOB COMPLETION NOTIFYING METHOD, IMAGE FORMING APPARATUS, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Kazuki ICHIKAWA, Gamagori-shi (JP)

(21) Appl. No.: 15/883,296

(22) Filed: Jan. 30, 2018

(30) Foreign Application Priority Data
Jan. 31, 2017 (JP) 2017-015712

(51) Int. Cl. G06F 3/12; H04M 1/725; G06K 15/02; H04N 1/00

(52) U.S. Cl. CPC G06F 3/1207; H04M 1/7253; G06F 3/1222; G06F 3/126; H04N 2201/0094; G06F 3/1238; G06K 15/1806; H04N 1/00307; G06F 3/1292

(57) ABSTRACT

An image forming apparatus is configured to detect a mobile communication terminal within a communication range of a first communication device during an image forming job, enable a job completion notifying function when the mobile communication terminal is detected, receive communication information including an e-mail address and/or connection information when the mobile communication terminal is detected, determine whether the notifying function is enabled, transmit the completion notification to the mobile communication terminal, pause the job after the notification is transmitted and start a job corresponding to the execution command when an input operation of the execution command is received during the job is paused.

### CROSS-REFERENCE TO RELATED APPLICATIONS

This application claims priority under 35 U.S.C. § 119 from Japanese Patent Application No. 2017-15712 filed on Jan. 31, 2017. The entire subject matter of the application is incorporated herein by reference.

### BACKGROUND

### Technical Field

The present disclosures relate to a job completion notifying method, an image forming apparatus employing the job completion notifying method and a non-transitory computer-readable recording medium containing instructions to cause the image forming apparatus to execute the job completion notifying method. It is noted that, the present disclosures relate to a method of transmitting a notification indicating completion of a job from the image forming device to a mobile communication terminal.

### SUMMARY

There has been known a technique in which a user ID and an e-mail address have been registered with an image forming apparatus, and completion of a job, error information and the like are transmitted from the image forming apparatus to a mobile communication terminal.

According to such a technique, a user is required to register the user ID and the e-mail address in advance, which requires a troublesome operation. Further, even though the user received such a notification transmitted to the mobile communication terminal, if the image forming apparatus receives another job before the user who received the notification reaches the image forming apparatus, the user needs to await completion of the job.

In consideration of the above problem, according to the present disclosures, there is provided a technique which lessens user's up-front time and effort for enabling the image forming apparatus to notify completion of a job, and enables the user of the mobile communication terminal to easily use the image forming apparatus.

According to aspects of the disclosures, there is provided an image forming apparatus, having a first communication device configured to execute a first communication with a mobile communication terminal, the first communication being a short-range communication according to a first communication method, a second communication device configured to execute a second communication according to a second communication method different from the first communication method, an image forming device configured to form an image, an operation device configured to receive a user operation, and a controller. The controller is configured to execute detecting the mobile communication terminal within a communication range of the first communication device by controlling the first communication device while the controller causes the image forming device to execute an image forming job, enabling a notifying function of notifying completion of the image forming job in response to detection of the mobile communication terminal, when the mobile communication terminal is detected, receiving, from the detected mobile communicate terminal, communication information including at least one of an e-mail address assigned to the detected mobile communication terminal, and connection information used to establish the second communication with the mobile communication terminal, by controlling the first communication device, and transmitting a completion notification of the image forming job to the mobile communication terminal detected by controlling the second communication device with use of the communication information in response to completion of the image forming job by the image forming device.

According to aspects of the present disclosures, there is also provided a method of notifying a completion notification for an image forming apparatus having a first communication device configured to execute a first communication with a mobile communication terminal, the first communication being a short-range communication according to a first communication method, a second communication device configured to execute a second communication according to a second communication method different from the first communication method, an image forming device configured to form an image, and an operation device configured to acquire a user operation. The method includes detecting the mobile communication terminal within a communication range of the first communication device by controlling the first communication device while the image forming device executing an image forming job, enabling a notifying function of notifying completion of the image forming job in response to detection of the mobile communication terminal, when the mobile communication terminal is detected, receiving, from the detected mobile communication terminal, communication information including at least one of an e-mail address assigned to the detected mobile communication terminal, and connection information used to establish the second communication with the mobile communication terminal, by controlling the first communication device, and transmitting a completion notification of the image forming job to the mobile communication terminal detected by controlling the second communication device with use of the communication information in response to completion of the image forming job by the image forming device.

According to aspects of the present disclosures, there is also provided a non-transitory computer-readable recording medium for an image forming apparatus having a first communication device configured to execute a first communication with a mobile communication terminal, the first communication being a short-range communication according to a first communication method, a second communication device configured to execute a second communication according to a second communication method different from the first communication method, an image forming device configured to form an image, an operation device configured to acquire a user operation, and a controller. The recording medium containing instructions executable by the controller. The instructions cause, when executed by the controller, the image forming apparatus to execute detecting the mobile communication terminal within a communication range of the first communication device by controlling the first communication device while the image forming device executing an image forming job, enabling a notifying function of notifying completion of the image forming job in response to detection of the mobile communication terminal, when the mobile communication terminal is detected, receiving, from the detected mobile communication terminal, communication information including at least one of an e-mail address assigned to the detected mobile communication terminal, and connection information used to establish the second communication with the mobile communication terminal, by controlling the first communication device, and transmitting a completion notification of the image forming job to the mobile communication terminal detected by controlling the second communication device with use of the communication information in response to completion of the image forming job by the image forming device.

### BRIEF DESCRIPTION OF THE ACCOMPANYING DRAWINGS

FIG. 1 is a block diagram of an image forming apparatus according to a first embodiment of the present disclosures.

FIG. 2 is perspective view of the image forming apparatus according to the present disclosures.

FIG. 3 is a block diagram of a mobile communication terminal according to the present disclosures.

FIG. 4 is an example of a completion notification screen.

FIG. 5 is a sequence chart illustrating procedure of a completion notification transmission process.

FIGS. 6A and 6B show a flowchart illustrating a job completion notifying process according to the first embodiment of the present disclosures.

FIG. 7 is a flowchart illustrating a job accumulating process.

FIGS. 8A and 8B show a flowchart illustrating the completion notifying process according to a second embodiment of the present disclosures.

### DETAILED DESCRIPTION OF THE EMBODIMENTS

### First Embodiment

Hereinafter, a first embodiment according to the present disclosures will be described with reference to the accompanying drawings.

[Configuration of MFP]

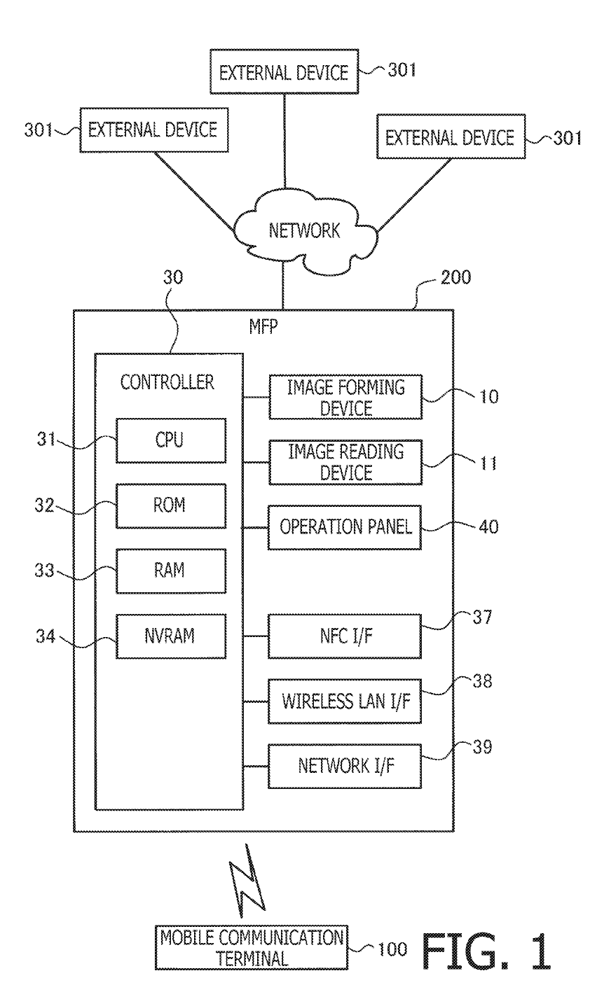

As shown in FIG. 1, an MFP 200 according to the present disclosures is configured to be connected with a plurality of external devices 301 through a network. The external devices 301 may include a server, a personal computer (PC), a printer, and an MFP. The MFP 200 is configured to be wirelessly connected with a mobile communication terminal 100. The mobile communication terminal 100 is a device the user can carry around. An example of the mobile communication terminal 100 may include a smartphone.

The MFP 200 has a controller 30 provided with a CPU 31, a ROM 32, a RAM 33 and an NVRAM 34. The controller 30 is connected to an image formation device 10 configured to print an image on a sheet, an image reading device 11 configured to read an image formed on an original document, an operation panel 40 acquiring the user's input operation, an NFC I/F 37, a wireless LAN I/F 38, and a network I/F 39. The RAM 33 is an example of a storage. The NFC I/F 37 is an example of a first communication device. The wireless LAN I/F 38 is an example of a second communication device.

The term “controller” 30 is a collective term including all components (e.g., the CPU 31) of hardware used to control the image forming apparatus, and does not necessarily mean a single piece of hardware. The CPU 31 is an example of a controller. It is noted that the controller 30 may be the controller set forth in the claims.

The image forming device 20 may be configured to form color images, or only monochromatic images. In the following example, it is assumed that the image forming device 10 is configured to form color images. Regarding an image forming method, the image forming device 10 may employ an electrophotographic image forming method, or an inkjet printing method. Further, the image reading device may be configured to perform a color scanning, or only a monochromatic scanning. In the following description, it is assumed that the image reading device is configured to perform the color scanning. Further, the reading mechanism employs a CCD or a CIS.

The ROM 32 stores firmware, which is a program to control the MFP 200, various settings, and initial values. The RAM 33 and the NVRAM 34 are used as a work area in which various control programs are developed and/or a storage area in which data is temporarily stored.

The CPU 31 controls various components of the MFP 200 in accordance with signals transmitted from control programs retrieved from the ROM 32 or various sensors, with storing processing results in the RAM 33 or the NVRAM 34.

The NFC I/F 37 is an interface which enables a wireless communication in accordance with an NFC (Near Field Communication) based on ISO/IEC 21481 or ISO/IEC 18092 international standards. The MFP 200 receives data transmitted from external devices through the NFC I/F 37. Further, the MFP 200 transmits data to the external devices through the NFC I/F 37.

The wireless LAN I/F 38 is an interface enabling a wireless communication in accordance with a Wi-Fi direct method (i.e., WFD method) based on IEEE 802.11 standards or one corresponding to the same. It is noted that the NFC method and the WFD method employ different communication methods (i.e., wireless communication standards), and a communication distance is longer, and a communication speed is faster in the WFD method than in the NFC method. The MFP 200 receives data transmitted from the wireless LAN I/F 38. Further, the MFP 200 transmits data to the external device through the wireless LAN I/F 38.

The WFD method is a communication method which is constructed such that a network is configured with a group owner device managing the network and client devices, and transmission/reception of data is enabled within the network. In order to enable a data communication with the external device through the wireless LAN I/F 38, it is necessary to establish the wireless communication with the external device, and construct the WFD network. According to the present embodiment, the MFP 200 serves as the group owner device when the WFD network is constructed, and the mobile communication terminal 100 serves as the client device. It is noted that the client device need not be limited to the mobile communication terminal 100, but other devices could belong to the WFD network as the client device.

The MFP 200 does not store connection information which is necessary to establish the wireless communication between the MFP 200 and the client device in accordance with the WFD method, and is configured to receive the connection information from the mobile communication terminal 100 through the NFC I/F 37. It is noted that, as the connection information, an SSID, which is an identifier for identifying the WFD network, or a password is used.

The network I/F 39 is hardware used to communicate with a device connected through a LAN cable. The MFP 200 is configured such that the network I/F 39 is connected to the plurality of external devices 301 through the network.

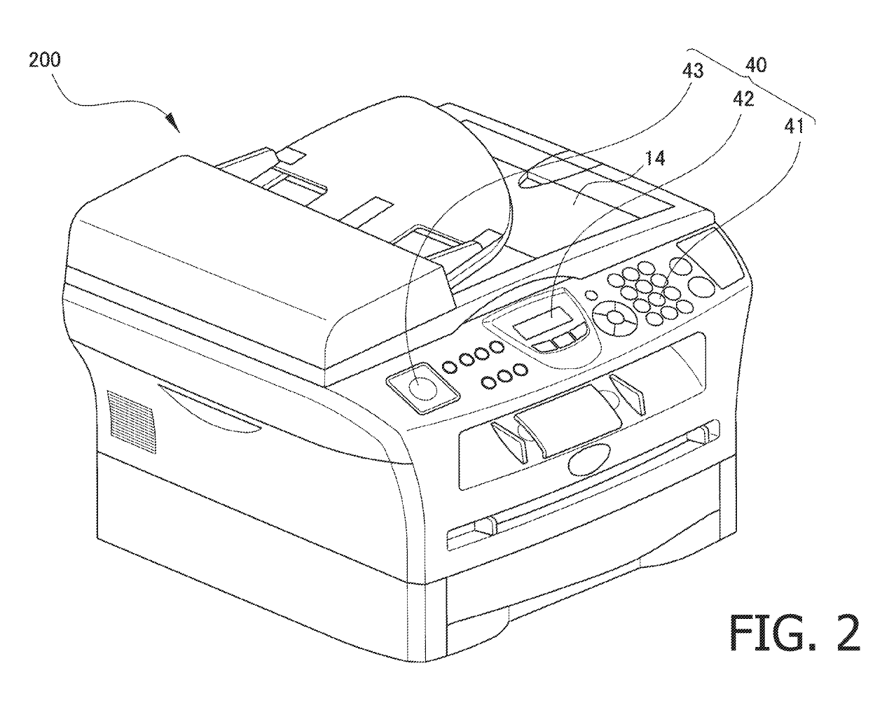

As shown in FIG. 2, the operation panel 40 has an input part 41 provided with various buttons through which the user's operation is input, and an LCD 42 configured to display messages and setting contents. The various buttons include, for example, an OK button for instructing start of image processing, and a cancel button for instructing cancellation of the image processing. Alternatively, or optionally, the MFP 200 may display the buttons on the LCD 42, and accepts the instructions in accordance with depressed position of the LCD 42 through a touch sensor provided thereon (i.e., the LCD 42 is configured as a touch panel). The input part 41 is an example of an operation device. It is noted that, when the LCD 42 is configured as the touch panel, the LCD 42 is an example of the operation device.

Further, as shown in FIG. 2, the operation panel 40 has an NFC reading device 43 configured to receive the wireless communication in accordance with the NFC method. The NFC reading part 43 is provided, as shown in FIG. 1, with the NFC I/F 37 shown in FIG. 1. The MFP 200 is in a state of detecting a device capable of executing the wireless communication in accordance with the NFC method, while MFP 200 is powered on, in accordance with the signal output by the NFC I/F 37. Therefore, when, for example, the user holds the mobile communication terminal 100 over the NFC reading device 43, the MFP 200 detects the mobile communication terminal 100, thereby the wireless communication in accordance with the NFC method between the mobile communication terminal 100 and the MFP 200 being enabled automatically. It is noted that an operation of holding the mobile communication terminal 100 over the NFC reading device 43 is an operation of locating the mobile communication terminal 100 within a communicatable range of the NFC interface 37, and it is not necessary that the mobile communication terminal 100 contacts the NFC reading device 43.

[Configuration of Mobile Communication Terminal]

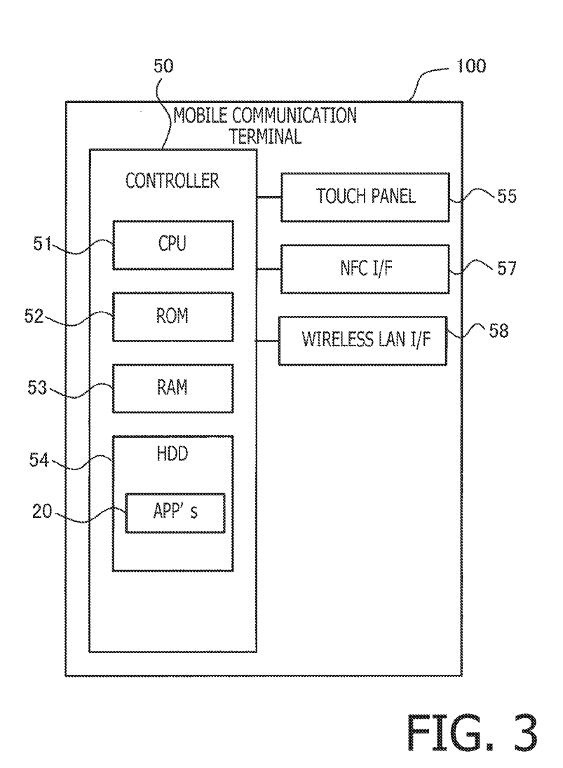

Next, referring to FIG. 3, a general configuration of the mobile communication terminal 100 will be described. The mobile communication terminal 100 includes a controller 50 provided with a CPU 51, a ROM 52, a RAM 53 and an HDD 54. Further, the mobile communication terminal 100 has a touch panel having functions of displaying and inputting, an NFC I/F 57 which is the communication interface enabling communication with external devices, and a wireless LAN interface 59, which are controlled by the controller 50.

In the HDD 54 of the mobile communication terminal 100, a browser for browsing files on the Internet, and device drivers respectively used to control various devices are installed. An application program 20 (hereinafter, also referred to as an app 20) configured to receive a job notifying completion of a previous job from the MFP 200 is also stored in the HDD 54.

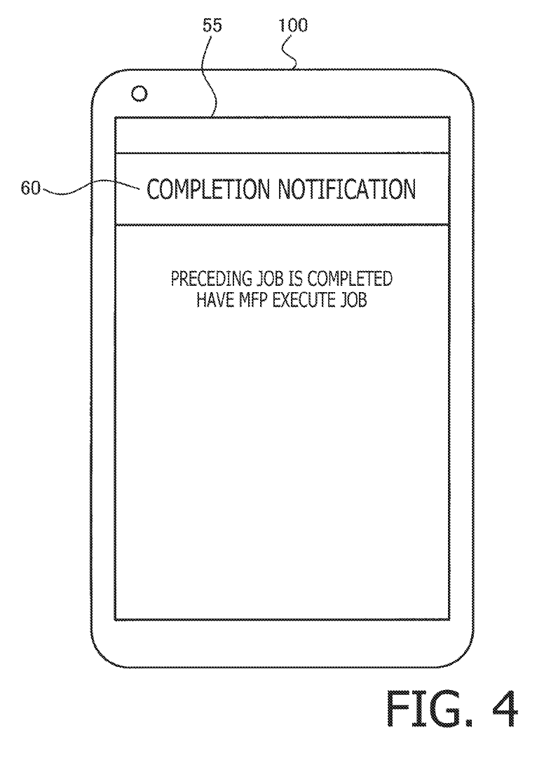

The app 20 is executed by the CPU 51 when the mobile communication terminal 100 receives an instruction to start the app 20 through the touch panel 55. when the mobile communication terminal 100 receives the completion notification from the MFP 200, the app 20 displays, for example, a completion notification screen 60 shown in FIG. 4 on the touch panel 55.

The CPU 51 executes various processes in accordance with the control programs retrieved from the ROM 52 and/or programs retrieved from the HDD 54, with storing results of calculation in the RAM 53 or the HDD 54. The operation of the app 20 described above is processed by the CPU 51.

The NFC I/F 57 is, similar to the NFC I/F 37 of the MFP 200, an interface enabling the NFC wireless communication. The wireless LAN I/F 58 is, similar to the wireless LAN I/F 38 of the MFP 200, an interface enabling the wireless communication in accordance with the WFD method. The mobile communication terminal 100 receives data transmitted by the external device through the NFC I/F 57 ore the wireless LAN I/F 58. Further, the mobile communication terminal 100 is capable of transmitting data to the external device through the NFC I/F 57 or the wireless LAN I/F 58.

[General Description of Completion Notification]

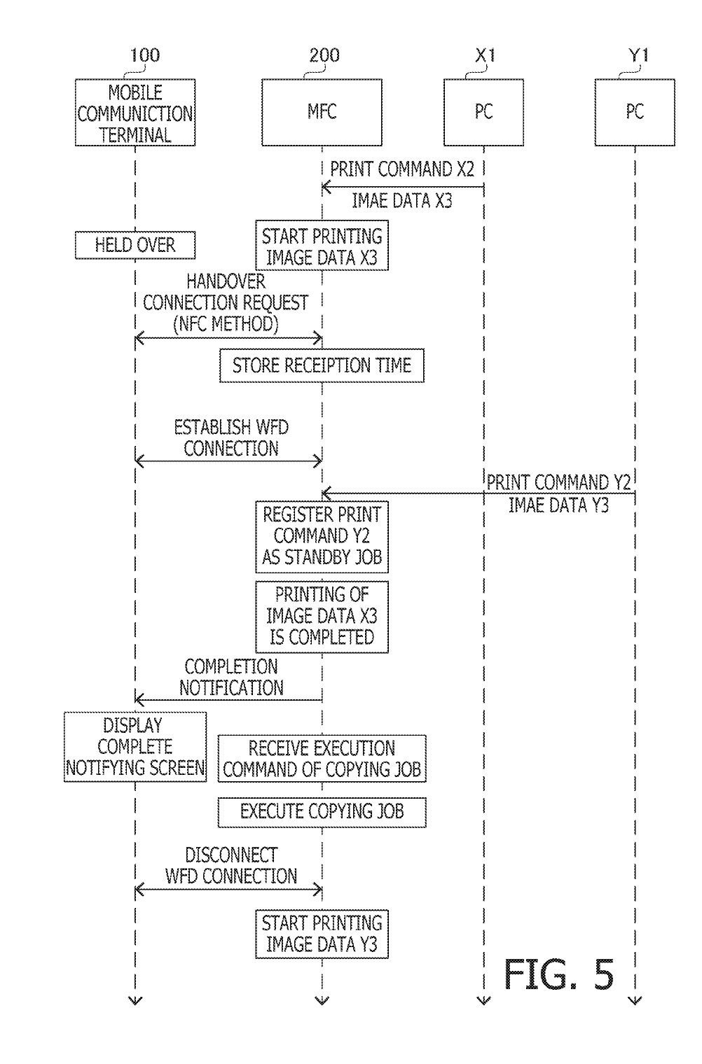

Next, a general description regarding the completion notification performed by the MFP 200 will be described, referring to a sequential chart shown in FIG. 5.

When the MFP 200 receives a print command X2 instructing to print image data X3 from a personal computer X1 of a user X, the MFP 200 controls the image forming device 10 to execute printing of the image data X3. Even when a user A comes to a place where the MFP 200 is placed in order to make a copy, the user A cannot execute copying. The user may wait for completion of the currently executed printing of the MFP 200. However, if the number of pages represented by the image data X3 is hundreds of pages, or other jobs different from the print command X2 are accumulated in the MFP 200, the user cannot know how long he/she should wait. Therefore, the user A holds his/her mobile communication terminal 100 over the MFP 200 so that a completion notification indicating that a preceding job is completed will be transmitted to his/her mobile communication terminal 100 later.

Then, the mobile communication terminal 100 of the user A transmits a handover connection request to the MFP 200 in accordance with the NFC method. When a reception time is stored, the MFP 200 establishes a communication with the mobile communication terminal 100 in accordance with the WFD method based on connection information received from the mobile communication information the user owns.

When the MFP 200 completes printing of the image data X3, the MFP 200 transmits the completion notification to the mobile communication terminal 100 the user A owns in accordance with the WFD method. The mobile communication terminal 100 of the user A displays, with user of the app 20, the completion notification screen 60 as shown in FIG. 4. With this configuration, the user A can recognize that the preceding job has been completed by checking the completion notifying screen 60 displayed on the mobile communication terminal 100, even if the user is in a place far from the MFP 200.

When the mobile communication terminal 100 of the user A receives the completion notification of the preceding job, the user A returns to the place where the MFP 200 is placed and executes copying by inputting a copy command through the operation panel 40. At this stage, if the MFP 200 has received a print command Y2 executing printing of image data X3 from a personal computer Y1 of a user Y before the copying job of the user A is started but after the reception time, the MFP 200 does not execute the printing command Y2 immediately, but set a printing job corresponding to the print command Y2 to a standby state. Thus, the user A can make his/her copying job be interrupted between the print command X2 of the user X and the print command Y2 of the user Y, so that the copying job of the user A can be executed in preference to the print job of the user Y.

When the MFP 200 completes the copying job of the user A, the MFP 200 disconnects the communication in accordance with the WFD method. Then, it becomes possible that other users can use the MFP 200. Thereafter, the MFP 200 executes the job corresponding to the print command Y2, which is in the standby state, and start printing the image data Y3.

[Controlling Procedure of Completion Notification Transmitting Process]

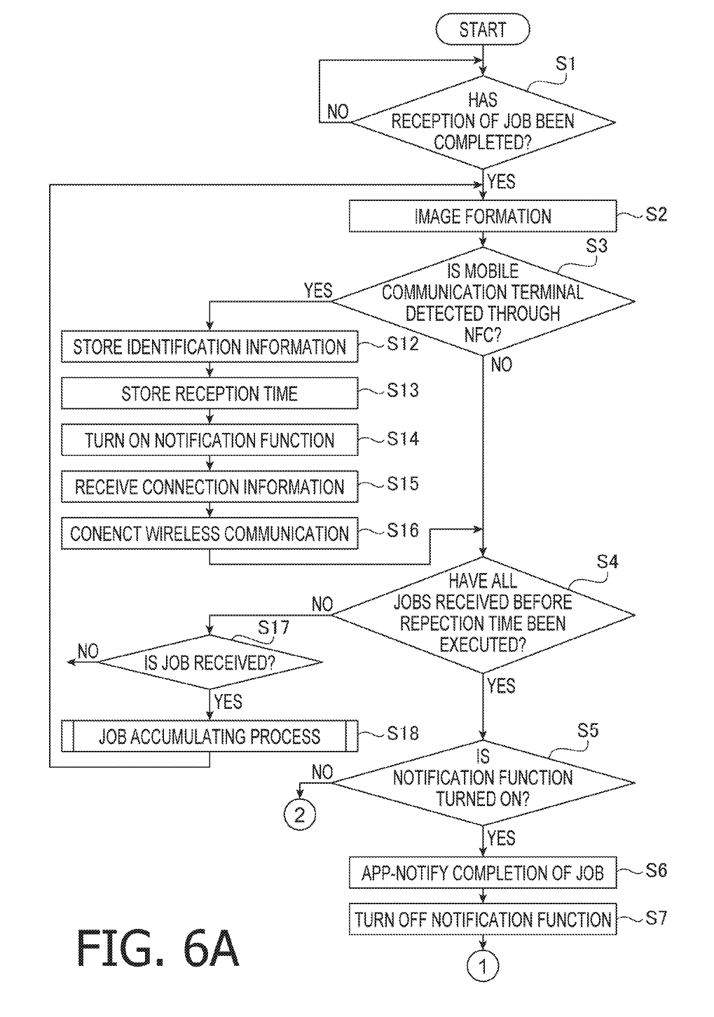

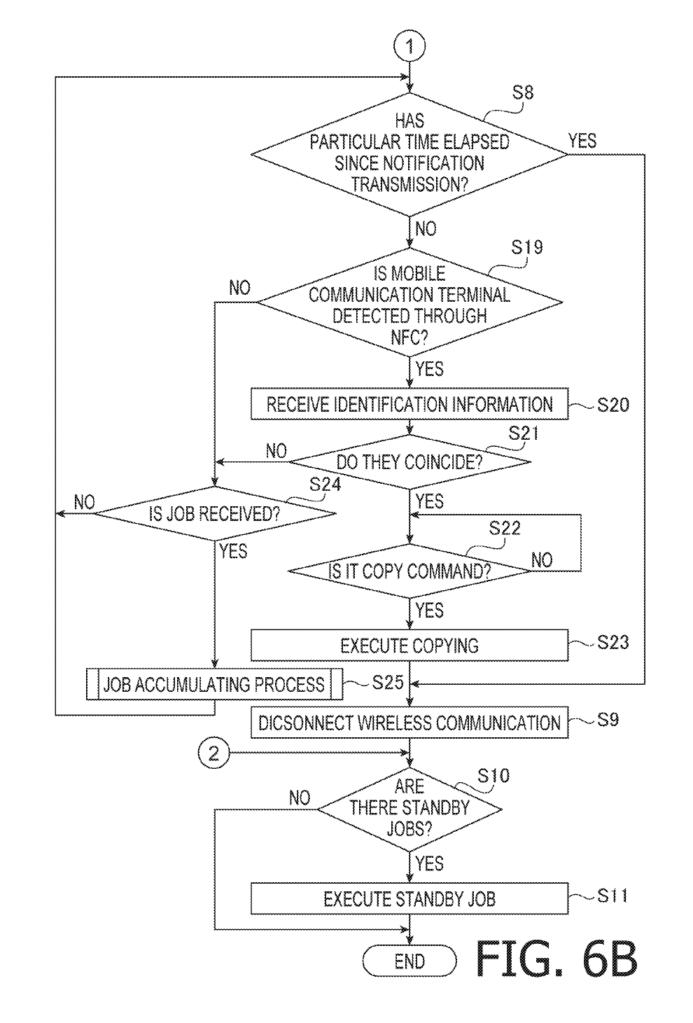

Next, a procedure of a completion notification transmitting process to realize the above-described completion notification will be described, referring to the flowchart shown in FIG. 6. The completion notification transmitting process is executed by the CPU 31 in response to reception, by the CPU 31, of the print command.

When the completion notification transmitting process is started, the CPU 31 controls the network I/F 39 to stay in a standby state until reception of a job corresponding to the print command is completed (S1: NO). When it is determined that reception of the job has been completed (S1: YES), the CPU 31 controls the image forming device 10 to start an image formation in accordance with the received job (S2).

Thereafter, the CPU 31 controls the NFC I/F 37 to determine whether the mobile communication terminal 100 is detected with user of the wireless communication according to the NFC method (S3). It is noted that the process of S3 is an example of a detecting process. The CPU 31 can detect the mobile communication terminal 100 by establishing a wireless communication according to the NFC method with the mobile communication terminal 100 located within a communicatable range of the NFC reading part 43. As above, the MFP 100 detects the mobile communication terminal held over the NFC reading part 43.

When the mobile communication terminal 100 has not been detected in accordance with the NFC method (S3: NO), the CPU 31 proceeds to S4.

When it is determined that the mobile communication terminal 100 is detected in accordance with the NFC method (S3: YES), the CPU 31 stores identification information (S12). The process in S12 is an example of a first identification reception process. When the mobile communication terminal 100 in which the app 20 is started is held over the NFC reading part 43, the CPU 31 controls the NFC I/F 37 to automatically receive the identification information which is information identifying the mobile communication terminal 100 itself, or the user who owns the mobile communication terminal 100 from the mobile communication terminal 100, and stores the received identification information in the RAM 33.

When the CPU 31 has received the identification information, the CPU 31 stores a reception time in the RAM 33, the reception time representing a time at which the mobile communication terminal 100 was detected (S13). The process in S13 is an example of a time storing process. With this configuration, a criterion to determine whether a newly received job is to be executed before or after an existing job is set. According to the present embodiment, the MFP 200 is configured to receive a job which is different from a job of the user of the mobile communication terminal 100. In such a case, whether the newly received job is a job to be executed before or after the job of which interruption reservation has been made can be determined based on the reception time.

Then, the CPU 31 stored information indicating that a notifying function is in an ON state in the RAM 33 (S14). The process in S14 is an example of a communication setting process. Upon execution of S14, the notifying function, which is a function of transmitting the completion notification indicating that a job is completed, to the mobile communication terminal 100 which is detected according to the NFC method is enabled.

Thereafter, the CPU 31 receives connection information which is used to establish a communication according to the WFD method from the mobile communication terminal 100 which was detected by controlling the NFC I/F 37, through a communication according to the NFC method (S15). The process in S15 is an example of a communication information receiving process. Then, the CPU 31 executes the wireless communication connection through the wireless LAN I/F 38 (S16). Thus, the CPU 31 makes the Wi-Fi connection using the connection information obtained in S13. With this configuration, it becomes possible that the MFP 100 can transmit the completion notification to the detected mobile communication terminal 100 even if the connection information of the detected mobile communication terminal 100 has not been registered in advance.

Next, the CPU 31 determines whether all the jobs stored before the reception time have been executed (S4). If there are one or more jobs which have been stored before the reception time (S4: NO), the CPU 31 controls the network I/F 39 to determine whether a job has been received (S17). It is because, when the MFP 200 establishes a network in association with a plurality of external devices 301, it is possible that the MFP 200 receives a job different from the currently executed image forming job. When another job is not being received (S17: NO), the CPU 131 returns to S2, and controls the NFC I/F 37 to detect the mobile communication terminal 100.

On the other hand, when the CPU 31 receives another job (S17: YES), the CPU 31 executes a job accumulating process (S18). The process of S18 is an example of a standby process.

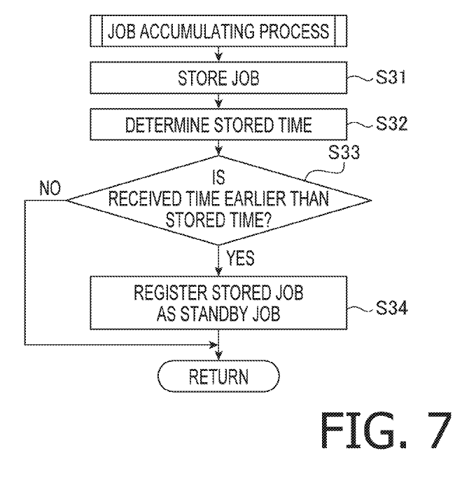

Hereinafter, referring to FIG. 7, the job accumulating process will be described. The CPU 31 accumulatively stores the received job in the RAM 33 (S31). In S31, the CPU 31 determines the time at which the CPU 31 stored the job in the RAM 33 as a storage time (S32). Thereafter, the CPU 31 determines whether the reception time stored in the RAM 33 in 5111 of FIG. 6 is earlier than the storage time determined in S32 (S33). That is, the CPU 31 determines whether the received job is a job received before the reception time, or after the reception time in S33.

When it is determined that the reception time is not earlier than the storage time (S33: NO), the CPU 31 returns to S2 of FIG. 6. That is, the CPU 31 executes printing of the job which was received before the reception time.

When it is determined that the reception time is earlier than the storage time (S33: YES), the CPU 31 registers the received job as the standby job (S34), and returns to S2 of FIG. 6. The standby job is an example of an acquired job. That is, the CPU 31 does not immediately execute the job received after the reception time and makes the MFP 200 be in the standby state in order to interrupt the job of the user, who has made a reservation of the completion notification, before the job received after the reception time.

In FIG. 6A, when it is determined that all the jobs stored before the reception time have been executed (S4: YES), the CPU 31 retrieves information regarding the notifying function from the RAM 33, and determines whether the retrieved information indicates that the notifying function is in ON state (S5). It is noted that the process of S5 is an example of a determining process. The CPU 31 determines whether the notifying function is in the ON state or not after all the jobs stored before the reception time have been executed. According to the above configuration, it becomes possible that the users of the jobs received before the reception time would not receive disadvantage due to interruption of a job. When the notifying function is not in the on state (S5: NO), the CPU 31 does not transmit the completion notification and proceeds to S10.

When the notifying function is set to ON (S5: YES), the CPU 31 controls the wireless LAN I/F 38 to transmit the completion notification of the job to the mobile communication terminal 100 which is a destination of the Wi-Fi connection (S6). It is noted that the process of S6 is an example of the notifying process. The mobile communication terminal 100 is configured such that, when the app 20 receives the completion notification of a job from the MFP 200, the completion notification screen 60 (see FIG. 4) is displayed. It is noted that a notification using an alarm or a vibrator may be used in association with the completion notification screen 50. According to the above configuration, the user can receive the completion notification of the job merely by holding the mobile communication terminal 100 over the MFP 200, even if the connection information of the mobile communication terminal 100 is not been registered with the MFP 200 in advance.

When the completion notification has been transmitted, the CPU 31 stores information indicating that the notifying function is in the OFF state in the RAM 33 (S7). Then, the notifying function to transmit the completion notification is set to OFF state.

Thereafter, the CPU 31 determines whether a particular period of time has passed since the completion notification was transmitted (S8). That is, if the copying job has not been executed over the particular period of time after the completion notification was transmitted, the CPU 31 automatically terminates the standby state so that other users can use the MFP 200. With this configuration, it is possible to avoid a situation where other users such as the user of the job the MFP 200 received after the reception time cannot use the MFP 200 when an execution command of a job has not been input through the input part 41 for a relatively long period of time.

When the particular period of time has not passed since the completion notification was transmitted (S8: NO), the CPU 31 controls the NFC I/F 37 to determine whether the mobile communication terminal 100 is detected within the particular period of time since the completion notification was transmitted in accordance with the NFC method (S19). The process of S19 is an example of a post-notification detecting process. The process in S19 is the same as the process in S3.

When the mobile communication terminal 100 has not been detected in accordance with the NFC method (S19: NO), the CPU 31 determines whether a job is received (S24). When no job is received (S24: NO), the CPU 31 returns to S8. When a job is received (S24: YES), the CPU 31 executes the job accumulating process (S25), and returns to S8. The process of S25 is an example of a standby process. Since the process in S25 is the same as the process in S18, description on S25 will be omitted. According to the above configuration, even after transmission of the completion notification, the CPU 31 sets the job received after the reception time to be in the standby state.

When the mobile communication terminal 100 is detected in accordance with the NFC method (S19: YES), the CPU 31 automatically receives the detected mobile communication terminal 100 or information identifying the owner of the mobile communication terminal 100 through the NFC I/F 37 (S20). The process of S20 is an example of a second identification reception process.

When the identification information is received, the CPU 31 determines whether the identification information received in S200 and the identification information obtained in S12 coincide with each other or not (S21).

When the both pieces of the identification information do not coincide (S21: NO), the CPU 31 proceeds to S24 without executing the copying job. In this case, it is likely that the user who owns the detected mobile communication terminal 100 is another user who is different from a user and owns a different mobile communication terminal to which the completion notification had transmitted. Therefore, if the copying job of the other user is executed, the user of the mobile communication terminal 100 to which the completion notification is transmitted may receive disadvantage that the copying job cannot be executed. That is, transmission of the completion notification would become meaningless.

In contrast, when the both pieces of the identification information coincide (S21: YES), the CPU 31 determines whether a copying command is input (S22). That is, the CPU 31 determines, through the input part 41 of the operation panel 40, whether the input operation of the execution command of copying has been received.

When there is no input of the copying command (S22: NO), the CPU 31 waits for input of the copying command.

When the copying command is received before the particular period of time has elapsed since the completion notification was transmitted (S22: YES), the CPU 31 executes the copying job (S23). The process of S23 is an example of a job interruption process. That is, since the CPU 31 receives the execution command of copying in S22, the CPU 31 controls the image reading device 11 to read an image on the original. Then, the CPU 31 controls the image forming device 10 to form an image based on the image data representing the image read by the image reading device 11.

According to the above configuration, when the user, who has received the completion notification by the mobile communication terminal, performs user collating within a particular period of time after the reception of the completion notification and executes the copying job, the user can used the MFP 200 immediately. Further, the user can insert his/her own copying job between the job received by the MFP 200 at the reception time and a job received by the MFP 200 after the reception time. Therefore, it is possible for the user to avoid disadvantage of waiting for completion of the preceding job in from of the MFP 200, or being unable to execute his/her own copying job when he/she once left from the MFP 200 and returned to the MFP 200.

When the copying job is completed, the CPU 31 controls the wireless LAN I/F 38 to disconnect the wireless communication between the MFP 200 and the mobile communication terminal 100 to which the completion notification was transmitted (S9). Thus, it becomes possible that the MFP 200 can communicate with another mobile communication terminal in accordance with the WFD method.

After disconnecting the wireless communication, the CPU 31 determines there is a standby job (S10). That is, the CPU 31 determines whether there is a job which is registered as standby job in the RAM 33. When it is determined that there is no standby job (S10: NO), the CPU 31 terminates the completion notification transmitting process. When it is determined that there is a standby job in the RAM 33 (S10: YES), the CPU executes the job registered as the standby job in the RAM 33 (S11). That is, when the copying job which was inserted before the job registered as the standby job is completed, the CPU 31 automatically terminates the standby state of the standby job so that other users can use the MFP 200. After execution of the standby job, the CPU 31 terminates the completion notification transmitting process.

It is noted that, even after the particular period of time has elapsed since the completion notification has been transmitted, the mobile communication terminal to which the completion notification has been transmitted has not been detected or not copying command is input (S8: YES), the CPU 31 controls the wireless LAN I/F 38 to disconnect the wireless communication with the mobile communication terminal to which the completion notification has been transmitted (S9). Then, the CPU 31 executes the process of S10 and S11 as above. When the input operation of the execution command of copying for a relatively long period, a period of time during which other users (e.g., the user of the job registered in the RAM 33 as the standby job) cannot use the MFP 200 becomes relatively long. Therefore, according to the present embodiment, when there is a standby job in the RAM 33 after the particular period of time has elapsed without receiving the input operation of the copying command since the completion notification of a job was transmitted, the CPU 31 executes the standby job. That is, the CPU 31 terminates the process of making the jobs received after the reception time be set to the standby state so that other users can use the MFP 200.

As described above, when the MFP 200 executes a communication with the mobile communication terminal 100 according to the NFC method during image formation, the MFP 200 receives the connection information to be referred to when the MFP 200 communicates with the mobile communication terminal 100 according to the WFD method. With this configuration, even though the connection information regarding the mobile communication terminal 100 has not been registered in advance, the MFP 200 can communicate with the mobile communication terminal 100 which is detected through the NFC I/F 37 controlled by the MFP 200 in accordance with the WFD method. Then, after completion of the preceding job, the MFP 200 controls the wireless LAN I/F 38 to transmit, according to the WFD method, the completion notification to the mobile communication terminal 100 which was detected through the communication according to the NFC method.

Thus, the user who owns the mobile communication terminal 100, to which the completion notification has been sent, can recognize based on the display of the mobile communication terminal 100, that the MFP 200 becomes available, even if the user is remote from the MFP 200. Further, the MFP 200 acquires the input operation of the execution command of a copying job through the input part 41 after transmission of the completion notification. When the execution command of copying has been received, the MFP 200 executes copying. Further, the MFP 200 interrupts acquired jobs (i.e., makes the acquired jobs be the standby jobs), which were acquired after the completion notification was transmitted till the input operation of the execution command of the copying job through the input part 41, for a particular period of time. Therefore, the user having the mobile communication terminal 100 which has received the completion notification can use the MFP 100 at a higher priority than the user(s) who performed the input operations of the acquired jobs.

### Second Embodiment

Hereinafter, the MFP 200 according to a second embodiment will be described with reference to the accompanying drawings. It is noted that the MFP 200 according to the second embodiment is substantially the same as that of the first embodiment except for the completion notification transmitting process. Therefore, in the following description, portions different from the first embodiment will be mainly described, while the control processes and the hardware configurations which are common between the first and second embodiments will be described briefly with reference to the drawings of the first embodiment, or description may be omitted.

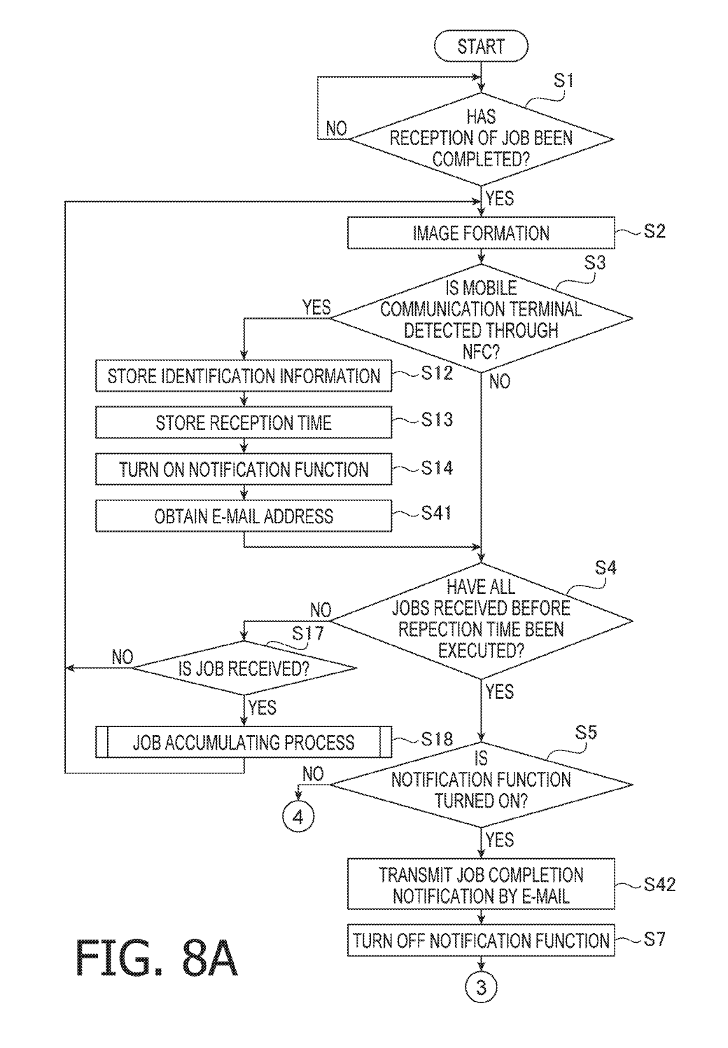

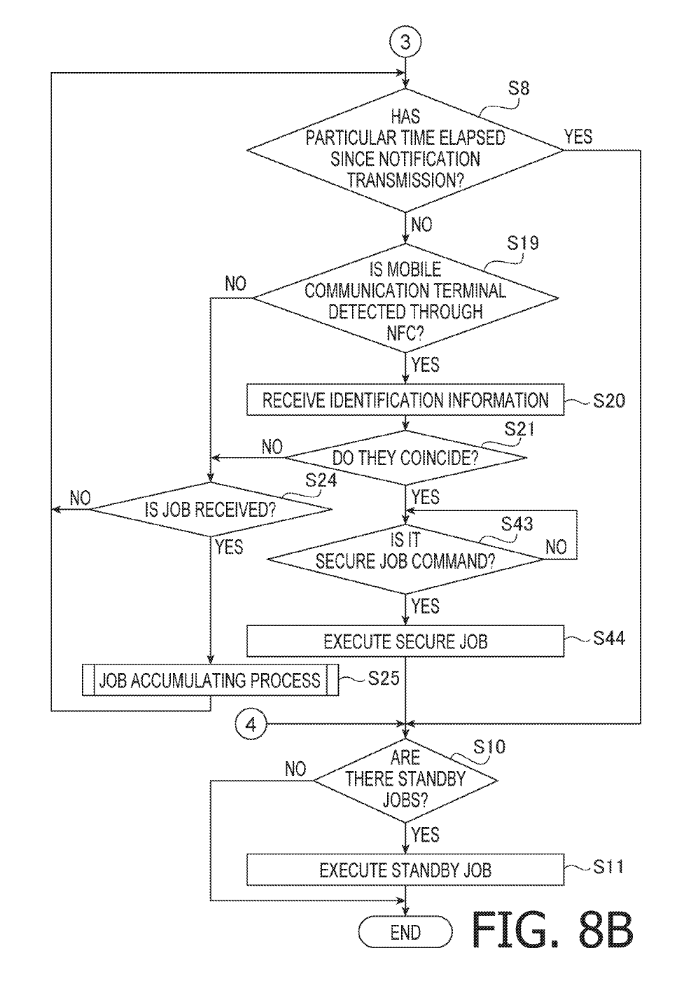

FIGS. 8A and 8B show a flowchart of the completion notification transmitting process according to the second embodiment, which is executed in response to the CPU 31 receiving the print command. It is noted that main differences of the process shown in FIGS. 8A and 8B (second embodiment) with respect to the process shown FIGS. 6A and 6B (first embodiment) include a feature that the MFP 200 transmits the completion notification by an e-mail and secure jobs are subject to the interruption registration. It is noted that, according to the second embodiment, the network I/F 39 is an example of a second communication device.

After reception of a job is completed (S1: YES), the CPU 31 executes image formation (S2). When the mobile communication terminal 100 is held over the NFC reading part 43 during image formation (S3: YES), the CPU 31 obtains the identification information (S12). Then, the CPU 31 stores the reception time (S13), and set the notifying function to be in ON state (S14). Thereafter, the CPU 31 obtains an e-mail address (S41). Specifically, the CPU 31 controls the NFC I/F 37 to receive the e-mail address assigned to the mobile communication terminal 100 from the same held over the NFC reading part 43, and stores the received e-mail address in the RAM 33.

Next, the CPU 31 executes all the jobs received before the reception time (S4: YES), set the notifying function to be in ON state (S5), and controls the network interface 39 to transmit the completion notification of the job to the e-mail address stored in the RAM 33 in S41 (S42). Thus, even if the user has not registered the e-mail address assigned to the mobile communication terminal with the MFP 200 in advance, simply by holding the mobile communication terminal 100 over the NFC reading part 43, the user can received the completion notification by e-mail.

After the completion notification was transmitted, when the mobile communication terminal 100 of the user who has received the completion notification is held over the NFC reading part 43 before the particular period of time has elapsed (S8: NO; S19: YES; S20; S21: YES), the CPU 31 determines whether a secure job command is received (S43). That is, the CPU 31 determines whether a selection of a job, input of a password and input of a print execution command have been done through the input part 41 of the operation panel 40.

When it is determined that the execution command of the secure job has not been received (S43: NO), the CPU 31 waits for reception of the same.

When the CPU 31 has received the execution command of the secure job after the completion notification was transmitted and before the particular period of time has elapsed (S43: YES), the CPU 31 executes the secure job (S44). The process of S44 is an example of the job interruption process. That is, since the execution command of the secure job has been received, the CPU 31 retrieves the secure job, which has been accumulated without being executed in the RAM 33, therefrom. Then, the CPU 31 controls the image forming device 10 to form an image in accordance with the image data included in the secure job.

As described in detail above, the MFP 200 according to the second embodiment is configured such that, when the MFP 200 executes the communication with the mobile communication terminal 100 in accordance with the NFC method, the MFP 200 receives the e-mail address assigned to the mobile communication terminal 100 therefrom. Thus, even if the e-mail address of the mobile communication terminal 100 has not been registered in advance, the MFP 200 can transmit the e-mail to the mobile communication terminal 100 detected through the communication according to the NFC method, through the network I/F 39. When the preceding job is completed, the MFP 200 transmit the completion notification, by e-mail, to the mobile communication terminal 100 detected through the communication according to the NFC method through the network. With this configuration, the user who owns the mobile communication terminal 100 which has received the completion notification recognizes that the MFP 200 becomes available. Further, after the completion notification is transmitted, the MFP 200 interrupts the jobs received after the reception time, and receives an input operation of an execution command of the secure job from the input part 41. Then, when the execution command of the secure job is input, the MFP 200 executes the secure job. The MFP 200 does not immediately execute jobs received after transmission of the completion notification and before reception of the execution command of the secure job, but make the jobs to be in the standby state. therefore, the user who owns the mobile communication terminal 100 which receives the completion notification can executes the secure job using the MFP 200 at a higher priority than the users who inputted jobs in the MFP 200 after the reception time.

It is noted that the above described embodiments only show illustrative configurations, and are not intended to limit the aspects of the present disclosures. That is, various modifications of the illustrative embodiments can be made without departing from the aspects of the disclosures. For example, the above-described control may be applied to a copier, a printer, a facsimile machine as well as the MFP.

In the above-described embodiments, the standby process is automatically released (S10 and S11 of FIG. 6B or FIG. 8B) after completion of the interrupted job. The configuration may be modified such that the user can transmit a release command to release the standby process from the user's personal computer or the mobile communication terminal 100 to the MFP 200. According to such a modification, when, for example, the user receives the completion notification of the preceding job but cannot immediately come to the MFP 200 to start the job due to a meeting or the like, by inputting the release command of the standby process, a period during which the other users cannot used the MFP 200 can be shortened.

It is noted that a plurality of jobs could be interrupted.

The MFP 200 may be configured to receive a plurality of reservations for transmitting a plurality of completion notifications. For example, the MFP 200 stores a plurality of reception times for respective reservations, and causes the plurality of jobs of the users who made the reservations among the other jobs in accordance with the respective reception times.

The above-described configurations may be modified such that the CPU 31 obtains both the connection information and the e-mail address. In such a case, when the MFP 200 cannot make a Wi-Fi connection with the mobile communication terminal 100 using the connection information, the MFP 200 can transmit the completion notification to the mobile communication terminal 100 by e-mail.

When the completion notification is transmitted to the mobile communication terminal 100 of the user who executes the copying job, the completion notification may be transmitted by e-mail. In such a case, S15 and S16 of FIG. 6A may be changed to a process of receiving the e-mail address and storing the same, and S6 of FIG. 6A may be changed to a process of transmitting the completion notification of the job to the received and stored e-mail address. In order to transmit the completion notification to the user who executes the secure job, the completion notification may be sent through the Wi-Fi connection. For example, S41 of FIG. 8A may be replaced with a process of receiving connection information, and establishing a wireless connection with the mobile communication terminal 100 detected through a communication according to the NFC method based on the received connection information. Further, S42 of FIG. 8A may be changed to a process of transmitting the completion notification through the wireless communication.

It is noted that S12 shown in FIGS. 6A and 8A, S19-S21 shown in FIGS. 6B and 8B, S22 shown in FIG. 6B and S42 shown in FIG. 8B may be omitted.

For example, S9 shown in FIG. 6B and FIG. 8B may be omitted, and a job received by the MFP 200 after the reception time may be set to be the standby sate until the copy job or the secure job is completed.

For example, in the input operation of the execution command of the secure job shown in FIGS. 8A and 8B, input of a password may not be included. That is, the process may be configured such that, simply by selecting a job and input the execution command of the selected job, the secure job is executed.

For example, the user may input authentication information manually by operating the input part 41.

The preceding job or the standby job may not only be the print command job received from the personal computer, but also output of the facsimile or copier function.

It is noted that processes disclosed in the illustrative embodiments may be executed by a single CPU, a plurality of CPU's, hardware such as ASIC, or any suitable combination thereof. Further, the processes disclosed in the illustrative embodiments may be realized by a non-transitory computer-readable recording medium storing the programs therefor, methods, and any other possible modes.

What is claimed is:

1. An image forming apparatus, comprising:
a first communication device configured to execute a first communication with a mobile communication terminal, the first communication being a short-range communication according to a first communication method;
a second communication device configured to execute a second communication according to a second communication method different from the first communication method;
an image forming device configured to form an image;
an operation device configured to receive a user operation; and
a controller,
the controller being configured to execute:
detecting the mobile communication terminal within a communication range of the first communication device by controlling the first communication device while the controller causes the image forming device to execute an image forming job;
enabling a notifying function of notifying completion of the image forming job in response to detection of the mobile communication terminal;
when the mobile communication terminal is detected, receiving, from the detected mobile communicate terminal, communication information including at least one of an e-mail address assigned to the detected mobile communication terminal, and connection information used to establish the second communication with the mobile communication terminal, by controlling the first communication device; and
transmitting a completion notification of the image forming job to the mobile communication terminal detected by controlling the second communication device with use of the communication information in response to completion of the image forming job by the image forming device.

2. The image forming apparatus according to claim 1,
wherein the controller is further configured to execute:
pausing execution of another job by the image forming device after transmitting a completion notification of the image forming job to the detected mobile communication terminal; and
starting a job corresponding to the execution command when an input operation of the execution command is received during execution of the job by the image forming device is paused after the controller transmitted the completion notification.

3. The image forming apparatus according to claim 1,
wherein the controller is further configured to determine whether the notifying function is enabled when the job being executed by the image forming device in response to detection of the mobile communication terminal.

4. The image forming apparatus according to claim 3,
wherein the controller is further configured to execute:
pausing execution of the job by the image forming device after transmitting a completion notification of the image forming job to the detected mobile communication terminal; and
starting a job corresponding to the execution command when an input operation of the execution command is received during execution of the job by the image forming device is paused after the controller transmitted the completion notification.

5. The image forming apparatus according to claim 1,
wherein the controller determines whether the notifying function is enabled, when the job, which is executed by the image forming device when the mobile communication terminal is detected, is completed,
wherein, when execution of the job by the image forming device is being paused, the controller controls the operation device after the completion notification of the job is transmitted to the detected mobile communication terminal to acquire an input operation of an execution command of a job causing the image forming device to form an image, and if there is a received job which has been received after the mobile communication terminal is detected till the execution command is input through the operating device, the controller pauses the received job, and
wherein, when the input operation of execution command is received when execution of the job by the image forming device is being paused, the controller starts a job corresponding to the execution command is started.

6. The image forming apparatus according to claim 1,
further comprising an image reading device configured read an image on an original,
wherein, when execution of the job by the image forming device is being paused, the controller acquires an execution command of a copying job of reading an image on the original by the image reading device and forming an image based on image data of the image on the original read by the reading device as the execution command through the operation device.

7. The image forming apparatus according to claim 1,
further comprising a storage configured to store a job causing the image forming device to form an image as a paused state,
wherein the controller executes the job stored in the stored state in the storage when the execution command of the job stored in the storage as the execution command through the operation command after the completion notification of the job is transmitted to the detected mobile communication terminal.

8. The image forming apparatus according to claim 1,
wherein the controller is further configured:
terminate pausing of the job by the image forming device when the input operation of the execution command has not been acquired since the completion notification was transmitted and a particular period has elapsed; and
when there is a job received except through the input operation of the execution command to the operation device since the mobile communication terminal is detected and before the execution command is input to the operation device, start executing the acquired job.

9. The image forming apparatus according to claim 1,
wherein the controller is further configured to:
terminate pausing execution of the job by the image forming device when the job started when execution of the job by the image forming device is being paused is completed; and
when there is a job received except through the input operation of the execution command to the operation device since the mobile communication terminal is detected and before the execution command is input to the operation device, start executing the acquired job.

10. The image forming apparatus according to claim 1,
further comprising a network interface,
wherein the controller is further configured to pause a job, which is received through the network interface since the mobile communication terminal is detected and after receiving an input operation of the execution command to the operation device as the acquired job to be paused.

11. The image forming apparatus according to claim 1,
wherein, when the mobile communication terminal is detected, the controller stores a detected time, and
wherein, when jobs causing the image forming device to form images and acquired before the time when the mobile communication terminal is detected in the detecting process has all been completed, the controller determines whether the notifying function is enabled when the job being executed by the image forming device as the mobile communication terminal is detected within the communication range of the first communication device.

12. The image forming apparatus according to claim 1,
wherein the controller is further configured to execute:
controlling the first communication device to receive identification information identifying one of the mobile communication terminal and the user of the mobile communication terminal when the mobile communication terminal is detected;
controlling the first communication device to detect the mobile communication terminal within a communication range of the first communication device when the job by the image forming device is being paused; and
controlling the first communication device to receive the identification information when the mobile communication terminal is detected within the communication range of the first communication device when the job by the image forming device is being paused, and
wherein, when the identification information received when the mobile communication terminal is detected and the identification information received when the job by the image forming device is being paused coincide with each other, the controller starts the job corresponding to the execution command.

13. The image forming apparatus according to claim 1,
wherein the second communication device is a network interface, and
wherein the controller receives an e-mail address assigned to the detected mobile communication terminal as the communication information, and
wherein the controller is configured to transmit the completion notification to the e-mail address.

14. The image forming apparatus according to claim 1,
wherein the second communication device is an interface configured to execute a wireless communication with the mobile communication terminal located within a communication range wider than the first communication range, and
wherein the controller is configured to:
receive connection information to establish the second communication as the communication information;
control the second communication device to establish the second communication with the mobile communication terminal detected after the connection information; and
control the second communication device to transmit the completion notification.

15. A method of notifying a completion notification for an image forming apparatus having a first communication device configured to execute a first communication with a mobile communication terminal, the first communication being a short-range communication according to a first communication method, a second communication device configured to execute a second communication according to a second communication method different from the first communication method, an image forming device configured to form an image, and an operation device configured to acquire a user operation,
the method including:
detecting the mobile communication terminal within a communication range of the first communication device by controlling the first communication device while the image forming device executing an image forming job;
enabling a notifying function of notifying completion of the image forming job in response to detection of the mobile communication terminal;
when the mobile communication terminal is detected, receiving, from the detected mobile communication terminal, communication information including at least one of an e-mail address assigned to the detected mobile communication terminal, and connection information used to establish the second communication with the mobile communication terminal, by controlling the first communication device; and
transmitting a completion notification of the image forming job to the mobile communication terminal detected by controlling the second communication device with use of the communication information in response to completion of the image forming job by the image forming device.

16. The method according to claim 15,
wherein the method further includes:
pausing execution of another job by the image forming device after transmitting a completion notification of the image forming job to the detected mobile communication terminal; and
starting a job corresponding to the execution command when an input operation of the execution command is received during execution of the job by the image forming device is paused after the controller transmitted the completion notification.

17. The method according to claim 15,
wherein the method further includes determining whether the notifying function is enabled when the job being executed by the image forming device in response to detection of the mobile communication terminal.

18. The method of notifying a completion notification according to claim 15,
wherein, it is determined whether the notifying function is enabled, when the job, which is executed by the image forming device when the mobile communication terminal is detected is completed,
wherein, when execution of the job by the image forming device is paused, the operation device is controlled after an input operation of an execution command of a job causing the image forming device to form an image is executed, and if there is a received job which has been received after the mobile communication terminal is detected till the execution command is input through the operating device, the received job is paused, and
wherein, when the input operation of execution command is received when execution of the job by the image forming device is paused, a job corresponding to the execution command is started.

19. A non-transitory computer-readable recording medium for an image forming apparatus having a first communication device configured to execute a first communication with a mobile communication terminal, the first communication being a short-range communication according to a first communication method, a second communication device configured to execute a second communication according to a second communication method different from the first communication method, an image forming device configured to form an image, an operation device configured to acquire a user operation, and a controller,
the recording medium containing instructions executable by the controller,
the instructions cause, when executed by the controller, the image forming apparatus to execute:
detecting the mobile communication terminal within a communication range of the first communication device by controlling the first communication device while the image forming device executing an image forming job;
enabling a notifying function of notifying completion of the image forming job in response to detection of the mobile communication terminal;
when the mobile communication terminal is detected, receiving, from the detected mobile communication terminal, communication information including at least one of an e-mail address assigned to the detected mobile communication terminal, and connection information used to establish the second communication with the mobile communication terminal, by controlling the first communication device; and
transmitting a completion notification of the image forming job to the mobile communication terminal detected by controlling the second communication device with use of the communication information in response to completion of the image forming job by the image forming device.

20. The recording medium according to claim 19,
wherein the instructions further cause, when executed by the controller, the image forming apparatus to execute:
pausing execution of another job by the image forming device after transmitting a completion notification of the image forming job to the detected mobile communication terminal; and
starting a job corresponding to the execution command when an input operation of the execution command is received during execution of the job by the image forming device is paused after the controller transmitted the completion notification.
